(19) United States
(12) Patent Application Publication
(10) Pub. No.: US 2026/0281623 A1
(43) Pub. Date: Sep. 17, 2026

(54) ELECTOACOUSTIC TRANSDUCER

(71) Applicant: Carl Maria Ingwar LECHLEITNER, Linz (AT)

(72) Inventor: Carl Maria Ingwar Lechleitner, Linz (AT)

(21) Appl. No.: 18/869,208

(22) PCT Filed: May 22, 2023
(86) PCT No.: PCT/AT2023/060164

§ 371 Date: Nov. 25, 2024

(30) Foreign Application Priority Data
May 25, 2022 (AT) A 50369/2022

(51) Int. Cl. H04R 7/04; H04R 7/10; H04R 7/24; H04R 31/00

(52) U.S. Cl. CPC H04R 7/045; H04R 7/10; H04R 7/24; H04R 31/003; H04R 2307/025; H04R 2307/027; H04R 2440/01

(57) ABSTRACT

An electroacoustic transducer (1), in particular a bending wave transducer, has at least a bending-resistant acoustic diaphragm (2) and a structure-borne sound transducer (3) that excites the acoustic diaphragm (2) to vibrate. The acoustic diaphragm (2) comprises a synthetic resin-coated support material (4), the sound emission surface (5) of which is formed of at least two, or in particular at least three, layers of synthetic resin (6) that are bonded materially to one another without any bonding means.

### TECHNICAL FIELD

The invention relates to an electroacoustic transducer, in particular a bending wave transducer, with at least one bending-resistant acoustic diaphragm and a structure-borne sound transducer that excites the acoustic diaphragm to vibrate.

### DESCRIPTION OF THE PRIOR ART

Electroacoustic transducers, also known as surface loudspeakers or exciters, use a structure-borne sound transducer equipped with a voice coil that functions according to the electrodynamic principle. This transducer is mechanically attached to the acoustic diaphragm, which can be formed by any sound-emitting body. The second part of the structure-borne sound transducer is usually attached to a second part, which is mechanically attached to the acoustic diaphragm, oscillating at perpendicular to the sound-emitting surface of the acoustic diaphragm. The structure-borne sound transducer converts electrical signals into kinetic energy and transfers them to any surface that can vibrate, such as a bed, sofa, mirror, cupboard, shelf, cabinet or even screens. In particular, very low frequencies, which cause problems for conventional subwoofers, can be realized.

The mechanical properties of the sound-emitting surface of the acoustic diaphragm are primarily responsible for a usable sound output. The acoustic diaphragm can only transmit tones or sounds if it vibrates mechanically and has a corresponding internal stress, in particular the bending-resistant internal stress. The acoustic diaphragm must therefore be at least sufficiently bending-resistant to be suitable for sound output.

An electroacoustic transducer that is used to excite a plate-shaped acoustic diaphragm or a screen to vibrate for the purpose of sound output is known, for example, from WO 9709842 A2, WO 9709853 A2 and WO 9709698 A1. DE 102007003165 A1 discloses a correction element for adapting the vibration behavior of the vibration system, consisting of an acoustic diaphragm and a structure-borne sound transducer.

DE102008059312 A1 discloses a further electroacoustic transducer, in particular a bending wave transducer, having at least one acoustic diaphragm and at least one oscillator that generates transverse bending waves in the acoustic diaphragm, wherein the acoustic diaphragm is a stiff, approximately rectangular plate body which is mounted in the region of two opposite edge edges, wherein at least one bearing is constructed as a damping part receiving an edge region in a fixed manner.

According to the teaching of WO 9937121 A1, acoustic transducers are attached to panel elements in such a way that the associated surface vibrations act on the panel elements and the resonance mode distribution of the same is utilized. WO 9952322 A1 from the same applicant shows a resonant multi-mode acoustic panel in which a transducer is attached. The acoustic panel has a cavity that absorbs and modulates the sound radiation emitted by the panel surface. DE102004032223 A1 discloses an audiovisual device with a flat element designed to display image information, which can be controlled to emit light, and with a flat, bending-resistant element designed to output sound information, the acoustic diaphragm, which can be excited to transverse bending vibrations and thus to sound radiation. According to the teaching, the sound-emitting element is essentially coextensive with the light-emitting element.

A flat loudspeaker with at least two essentially flat acoustic diaphragms of different sizes is known from DE102015104478 A1, which are each held in a frame at the edge and which are each excited via an electrodynamic transducer, i.e. a structure-borne sound transducer, to exciting bending waves on the respective sound membrane, wherein the membranes are each formed from a bending-resistant polystyrene plate coated on both sides, which is connected to its respective surround in the manner of a conventional cone loudspeaker via an elastic edge connection.

The main disadvantage of the previously known electroacoustic transducers is that the sound they produce is of only moderate listening quality and that the realizable frequency responses in the audible range are far from those of conventional hi-fi loudspeakers.

### SUMMARY OF THE INVENTION

The invention is therefore based on the task of specifying an electroacoustic transducer of the type described at the beginning, which is characterized by improved sound reproduction and that preferably independently of the geometry of the acoustic diaphragm, which does not necessarily have to be that of a flat plate.

The invention solves the problem by utilizing an acoustic diaphragm that comprises a synthetic resin-coated carrier material, the sound-emitting surface of which is formed by at least two, in particular at least three, synthetic resin layers that are firmly bonded to one another without the use of any bonding means.

Depending on the type of carrier material, a coupling agent can be arranged between the carrier material and the first synthetic resin layer. It is essential that the acoustic diaphragm comprises a synthetic resin-coated carrier material whose sound-emitting surface is formed by at least two, in particular by at least three, synthetic resin layers that are bonded to one another firmly without the use of any bonding means, which means that no separate bonding agent is provided between these synthetic resin layers. The individual layers preferably consist of one and the same synthetic resin. The synthetic resin layers are not simply glued together; glued layers do not form a firm bond with each other, but are applied one after the other in a specific time frame so that they are firmly bonded to each other. This means that the synthetic resin layers are held together by atomic or molecular forces without a separate bonding agent or adhesive agent and cannot be detached from each other without causing damage. To do this, the second and any subsequent layers must always be applied to the previous layer before the hardener-added synthetic resin of the previous layer is completely cross-linked. In turn, the previous layer must already be partially cross-linked at this point so that, on the one hand, the necessary firmly bonded layer connection is formed and, on the other hand, the partially cross-linked layer is already sufficiently dimensionally stable so that it does not form any unwanted surface unevenness when the next layer is applied. This creates an acoustic diaphragm that, in contrast to a single layer, is so bending-resistant due to the mutual tension of the several individual layers that the acoustic diaphragm is particularly suitable for sound emission. When the two or more synthetic resin layers are manufactured, the layers are firmly bonded to each other without the use of any bonding means, resulting in an acoustic diaphragm in which stresses develop between the layers that have an effect analogous to a taut string of a musical instrument. Excellent sound emission behavior has been measured when the sound-emitting surface has several layers of synthetic resin. Up to ten layers have been tested to date. It is up to the expert to determine a reasonable number of acoustic diaphragms and structure-borne sound transducers. The layers of synthetic resin that are firmly bonded to one another can be coated with a conventional varnish if a special appearance is desired.

The synthetic resin of the synthetic resin layers is preferably based on a polymer system that can be cross-linked by means of polyaddition, preferably an epoxy system or a polyurethane system. Based in this context means that the synthetic resin, in addition to the polymer system usually comprising at least one hardener and at least one prepolymer, can also comprise additives such as fillers, dyes and the like.

The synthetic resin of the synthetic resin layers can be a preferably two-component epoxy system comprising an amine-based hardener and/or a preferably three-component polyurethane system comprising a hardener based on blocked isocyanates. Both epoxy synthetic resins and polyurethane synthetic resins have proven to be particularly suitable for the intended use and deliver good results. During and after processing, the synthetic resin (thermoset) has the appearance of a liquid glass.

To adjust the hardness and the mechanical and optical properties, the synthetic resin of the synthetic resin layers can comprise at least one further additive, such as an inorganic filler, for example aluminum oxide. It has also been shown that the addition of an inorganic filler can, in particular, reduce the usually undesirable shrinkage of the cured synthetic resin layers without impairing the optical or acoustic properties of the acoustic diaphragm.

The carrier material can be almost any material of any geometry that is suitable for being coated with the firmly bonded layers of synthetic resin, in particular a composite material in a sandwich construction, a textile, a hollow body, a body made of glass fiber reinforced plastic and/or a wooden body. So-called Dibond panels, a stiff composite material in a sandwich construction, have proven to be particularly suitable as a carrier material. Dibond panels usually comprise two aluminum cover layers, between which a polyethylene core is embedded. The acoustic diaphragm or the electroacoustic transducer is ultimately, for example, a picture, a sculpture, a wall or ceiling paneling or the like.

In a simple case, a commercially available structure-borne sound transducer can be attached to the acoustic diaphragm and rigidly connected to it, for example by gluing. However, since this is not always possible, it can be advantageous if the structure-borne sound transducer is connected to the acoustic diaphragm via a connecting element that is attached to or integrated into the acoustic diaphragm. This connecting element forms an adapter to which the structure-borne sound transducer can be attached. The connecting element is geometrically designed in such a way that it can be connected to the acoustic diaphragm on the one hand and to the structure-borne sound transducer on the other hand in the best possible way, and the sound waves generated by the structure-borne sound transducer can be introduced into the acoustic diaphragm with as little unwanted loss as possible.

In order to be able to introduce the sound waves into the acoustic diaphragm even at particularly exposed points where there would be no room for mounting the structure-borne sound transducer, the structure-borne sound transducer can be connected to the connecting element via a coupler and the structure-borne sound transducer can be arranged at a distance of 2 to 800 mm from the acoustic diaphragm, which is bridged by the coupler. In a simple case, the coupling is a rod that engages at one end with the connecting element and at the other end with the structure-borne sound transducer. The coupler (rod) can in turn be connected to the structure-borne sound transducer via a corresponding connecting element. Thus, a suitable connecting element (adapter) can be provided between the coupler and the carrier material and between the coupler and the structure-borne sound transducer to ensure a clean introduction of the structure-borne sound from the structure-borne sound transducer into the acoustic diaphragm. It is also conceivable to couple the two connecting elements directly to each other, i.e. without an intermediate coupler, for example by means of a screw cap, bayonet lock or similar.

In particular, if a coupler is planned, but not exclusively for this case, it is recommended that the structure-borne sound transducer is suspended in a housing of the electroacoustic transducer so as to oscillate freely with respect to the acoustic diaphragm. For this purpose, a spring suspension for the structure-borne sound transducer or a suspension in the manner of a microphone spider or similar is recommended.

If the electroacoustic transducer comprises a carrier material in a sandwich construction, comprising two metal layers, in particular aluminum layers, between which an electrically insulating core is arranged, the electrical lines leading from a connection point to the structure-borne sound transducer can be incorporated in the manner of a printed circuit board into at least one of the two metallic layers. The carrier material, i.e. the metallic layer itself, thus forms a printed circuit board with which electrical signals are conducted from a suitable connection point to the structure-borne sound transducer. To do this, current-carrying lines, for example, are incorporated into the metallic layer by removing material between the conductors. The transmission of music, speech or sound expertise to an amplifier, which may be located in the electroacoustic transducer and connected to the connection points by suitable means, is done via Bluetooth, Wi-Fi or cable.

In order to further improve the design and repair options for the electrical contact between the structure-borne sound transducer and the circuit board and between the circuit board and an electrical signal generator, it is proposed that the negative or positive contact pole of the connection point on the circuit board and/or the negative or positive contact pole of a contact point of the structure-borne sound transducer are each formed by an adhesive electrode electrically connected to a respective negative electrical line or positive electrical line. These features mean that any electrical soldered connections that can no longer be disconnected without causing damage can be dispensed with. In addition, the advantage arises that, with the help of the adhesive electrodes, the local arrangement of the corresponding negative or positive connection point on the circuit board, in particular, can be freely selected to a large extent, thus enabling a high degree of flexibility in the arrangement of those connection points. The adhesive electrode that can be glued to the metal surface is constructed in such a way that it is familiar, for example, from electrode pads used in TENS or EMS therapy applications. For example, the electrode base can be formed from a silicone matrix or similar, in which the fillers required for electrical conductivity are embedded. The fillers that can be used include, for example, various carbon-based fillers, in particular soot, graphite or carbon nanotube particles, but also metal-based fillers or suitable inorganic fillers. It goes without saying that the adhesive electrode has a corresponding cable connection or similar.

In particular, if the electroacoustic transducer is exposed to strong climatic or thermal fluctuations, it may be necessary to place the structure-borne sound transducer in a gas-tight envelope filled with an inert gas such as helium. This helps to prevent oxidation, especially on the voice coil and iron core of the structure-borne sound transducer, even if it shows various hairline cracks after heavy use, thus increasing the service life of the electroacoustic transducer.

To improve the low-frequency bass response, the structure-borne sound transducer can be arranged between the acoustic diaphragm and a bass reflex bell to form a bass reflector. For this purpose, the bass reflex bell is arranged in a housing of the electroacoustic transducer and placed against the acoustic diaphragm without contact at the free edge of the bell in such a way that the free edge of the bell does not touch the acoustic diaphragm when sound is emitted and a pressure chamber forms between the acoustic diaphragm and the volume spanned by the bell. The bass reflex bell can be attached to the structure-borne sound transducer by means of a holding device.

A process for manufacturing an acoustic diaphragm according to the invention is characterized in that a first synthetic resin layer is first applied to a sound-emitting surface of a shaping carrier material, after which, before the first synthetic resin layer has completely cured, a second synthetic resin layer is applied to the first synthetic resin layer in such a way that the first and second synthetic resin layers are firmly bonded to one another without the use of any bonding means, after which, optionally, a third synthetic resin layer or several synthetic resin layers in succession are applied in the same way.

The above-mentioned features and properties of the acoustic diaphragm and thus of the synthetic resin layers apply analogously.

According to one example of an embodiment, a first layer of synthetic resin is first applied to the shaping carrier material. The synthetic resin used is a two-component epoxy system with an amine-based hardener and/or a preferably three-component polyurethane system with a hardener based on blocked isocyanates, for example, Gobbetto flooring resins (e.g. DEGA POLIEPO GC 505 EXTRA). Preferably 2 or 3-component means that various additives may still be present, such as an inorganic additive. The resin is diluted with high-percentage alcohol for processing. During processing, the carrier material is always vibrated with a vibrating machine. For the first synthetic resin layer, an amount of 1.2 to 3.2, in particular 2 to 2.4 and preferably 2.2 kg/m 2 (kilograms of resin per m 2 of carrier matieral) is used.

Subsequently, before the first synthetic resin layer has fully cured, a second synthetic resin layer is applied to the first synthetic resin layer in such a way that the first and second synthetic resin layers are firmly bonded to one another without the use of any bonding means, for which purpose it is necessary to apply the second or each further synthetic resin layer in a time window of 6.5-8 h, in particular of 7-7.5 h, after application of the first or the previous synthetic resin layer. The exact time is determined in particular by the process temperature and the ambient temperature and the relative humidity. For the second and each further synthetic resin layer, a quantity of 0.6 to 1.2, in particular of 0.8 to 1 and particularly preferred of 0.9 kg/m 2 (kilograms of resin per m2 of carrier matieral) is used.

Preferably, several layers of synthetic resin can be applied to the carrier material up to a total thickness of 3.5 mm.

The invention also relates to an acoustic diaphragm produced by the method described.

### BRIEF DESCRIPTION OF THE INVENTION

The subject of the invention is shown in the drawing, for example, wherein

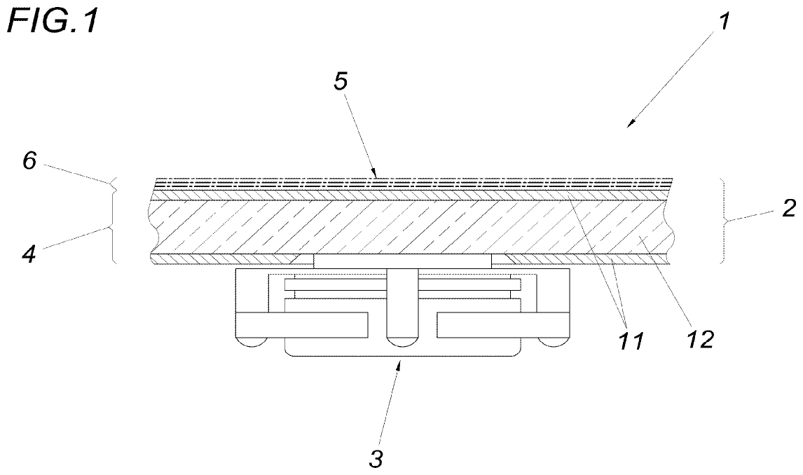

FIG. 1 shows a section of an electroacoustic transducer with a bending-resistant acoustic diaphragm and a structure-borne sound transducer in cross-section,

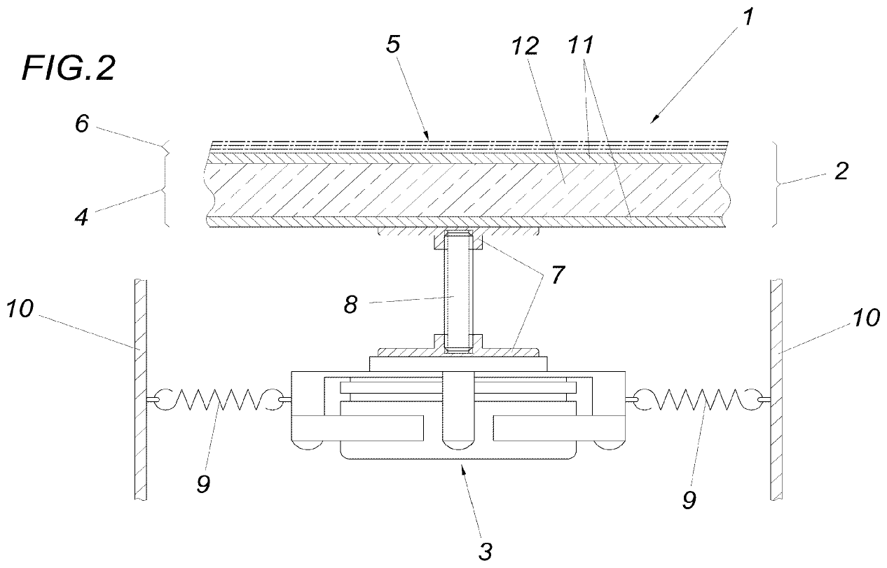

FIG. 2 shows a cross-section of a design variant of an electroacoustic transducer,

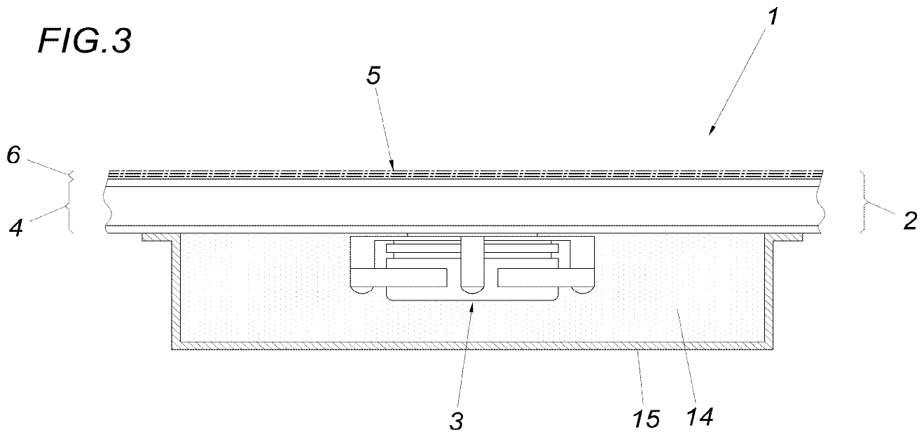

FIG. 3 shows a cross-section of a design variant in which the structure-borne sound transducer is inserted into a gas-tight envelope filled with an inert gas,

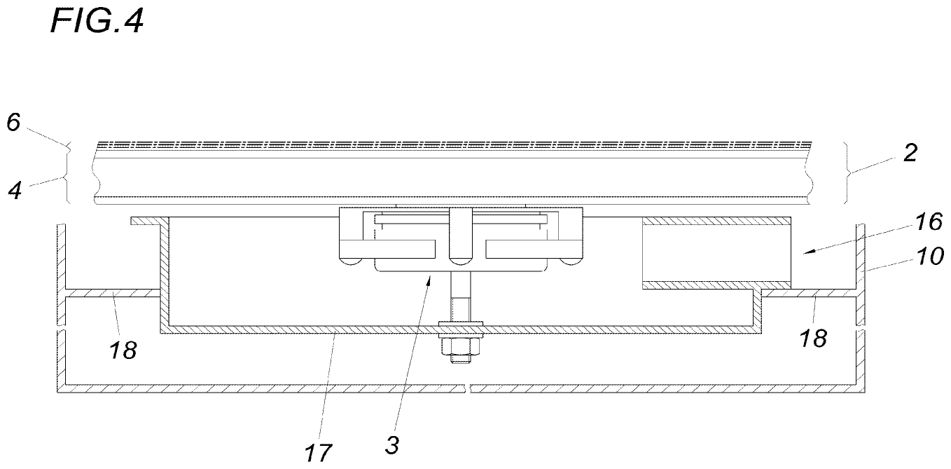

FIG. 4 shows a design variant in which the structure-borne sound transducer is arranged between the acoustic diaphragm and a bass reflex bell in cross-section,

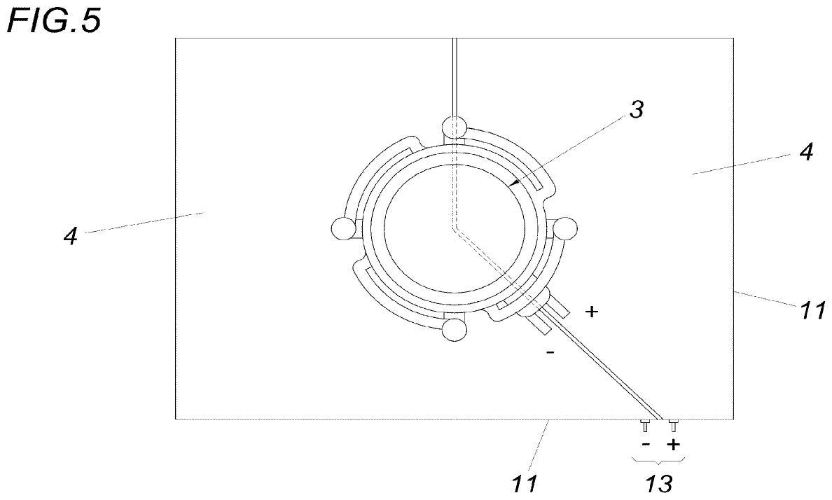

FIG. 5 shows a design variant in which the electrical lines leading to the structure-borne sound transducer are incorporated into a metallic layer of the carrier material in rear view,

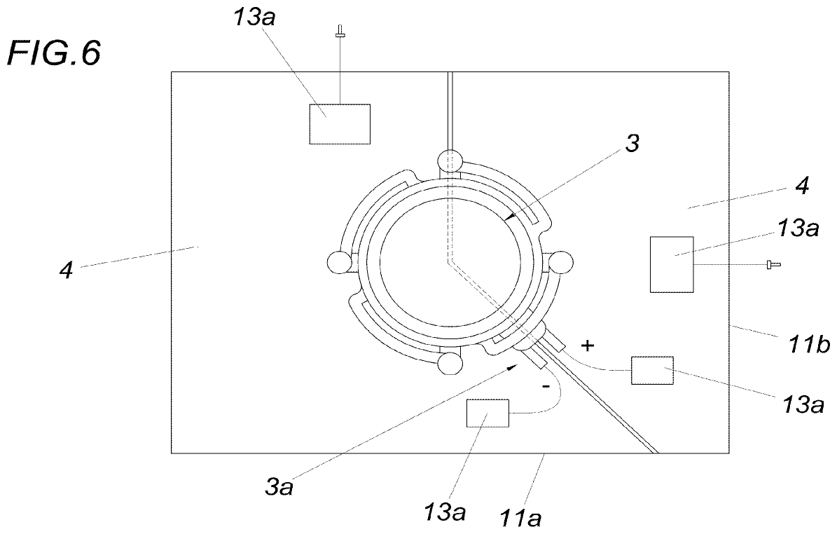

FIG. 6 several construction variants of an electroacoustic transducer in various views,

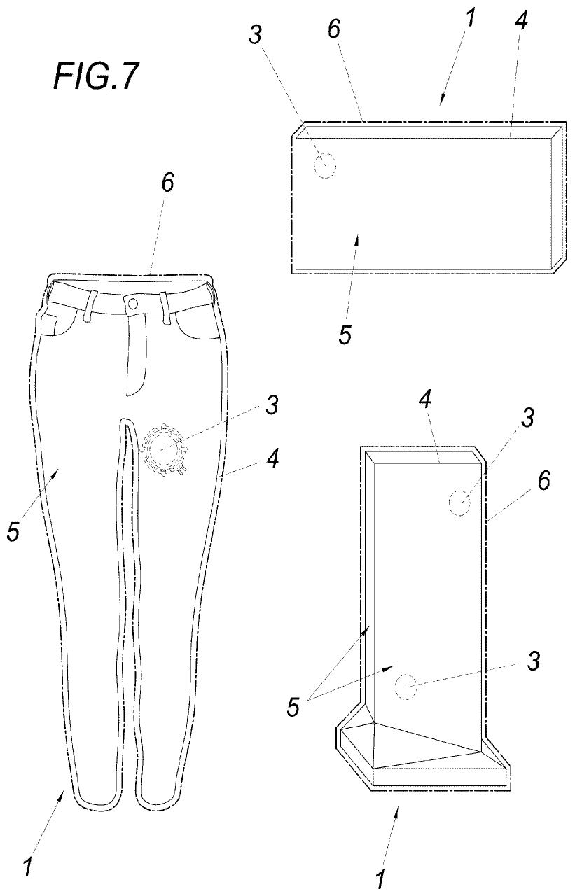

FIG. 7 shows a corner area of a panel-shaped electroacoustic transducer in cross-section and

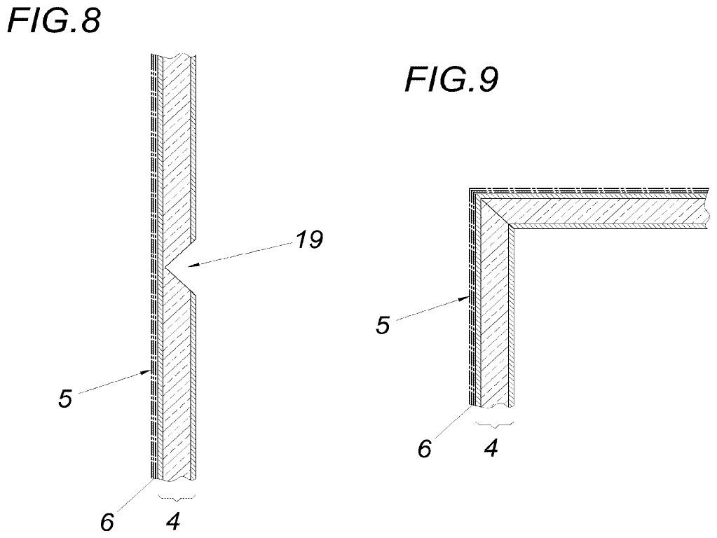

FIG. 8 shows the corner area from FIG. 7 with flanks bent backwards out of the sound-emitting surface.

### WAYS OF IMPLEMENTING THE INVENTION

The invention relates to an electroacoustic transducer 1, in particular a bending wave transducer, with at least one bending-resistant acoustic diaphragm 2 and a structure-borne sound transducer 3 that causes the acoustic diaphragm 2 to vibrate.

The acoustic diaphragm 2 comprises a synthetic resin-coated carrier material 4, the sound-emitting surface 5 of which is formed by at least two, in particular by at least three, synthetic resin layers 6 forming the synthetic resin coating of the carrier material 4, which are connected to one another in a firmly bonded manner without the use of bonding means.

The synthetic resin of the synthetic resin layers 6 is based either on an epoxy system with an aminic hardener or on a polyurethane system with a hardener based on blocked isocyanates. There may also be more than three synthetic resin layers 6. The synthetic resin of the synthetic resin layers 6 includes at least one other additive, such as a filler and/or nucleating agent.

The carrier material 4 can be a composite material in sandwich construction with two aluminum layers about 0.3 millimeters thick, with a polyethylene core embedded between them, or it can be a textile, a body made of glass-fiber-reinforced plastic, or a wooden body. In particular, FIG. 6 shows several design variants of an electroacoustic transducer in various views, namely a pair of trousers on the left, a picture or wall panel at the top right or a sculpture at the bottom right, all of which form the carrier material that is coated with at least two layers of synthetic resin 6 that are joined to one another without the use of bonding means.

The Structure-borne sound transducer 3 is connected to an acoustic diaphragm 2 by means of a connecting element 7 attached to or integrated in the acoustic diaphragm 2. In accordance with the design examples shown in FIGS. 3 and 4, the structure-borne sound transducers 3 are attached directly to the acoustic diaphragm 2, in particular by gluing. According to the embodiments shown in FIGS. 1 and 2, the structure-borne sound transducers 3 are either inserted directly into a milled groove on the back of the acoustic diaphragm (FIG. 1) or connected to the acoustic diaphragm 2 via a connecting element 7 integrated into the acoustic diaphragm 2 (FIG. 2). In particular, the connecting element 7 can be cast into a recess in the acoustic diaphragm 2 for secure anchoring.

The structure-borne sound transducer 3 is connected to the connecting element 7 via a coupler 8, in this case a threaded rod, whereby the structure-borne sound transducer 3 can be arranged at a distance of 2 to 800 mm from the acoustic diaphragm 2. The structure-borne sound transducer 3 can be suspended by means of springs 9 in a housing 10 of the electroacoustic transducer so that it can oscillate freely with respect to the acoustic diaphragm 2. According to FIG. 2, the coupler 8 is a rod that engages at one end on the connection element 7 towards the acoustic diaphragm and at the other end on the structure-borne sound transducer 3 via a further connection element 7. The coupler 8 is in turn connected to the structure-borne sound transducer via a correspondingly adapted connection element 7, in order to ensure a clean introduction of the structure-borne sound from the structure-borne sound transducer 3 into the acoustic diaphragm 2.

For the electroacoustic transducer 1, a carrier material 4 in a sandwich construction can comprise two metal layers 11, in particular aluminum layers, between which an electrically insulating core 12 is arranged, wherein the electrical lines leading from a connection point 13 to the structure-borne sound transducer 3 are incorporated in the manner of a printed circuit board into at least one of the two metallic layers 11 (FIG. 5).

According to a further embodiment shown in FIG. 6, both the negative and positive contact poles of the connection point 13 and the negative and positive contact poles of a contact point 3a of the structure-borne sound transducer 3 are each formed by an adhesive electrode 13a electrically connected to a respective negative electrical line 11a or positive electrical line 11b.

The structure-borne sound transducer 3 can be used in a gas-tight casing 15 filled with an inert gas 14 (FIG. 3).

In addition, the structure-borne sound transducer 3 can be arranged between the acoustic diaphragm 2 and a bass reflex bell 16 to form a bass reflector 17, which is either suspended in the housing 10 by means of holding means 18 or suspended from the structure-borne sound transducer 3 by means of a corresponding holding means, in this case a non-magnetic screw bolt-nut combination. The enclosure may be lined with a sound-absorbing material, as is common with conventional loudspeakers, to dampen unwanted sound reflections in the enclosure 10.

FIGS. 7 and 8 show the production of the flanks of a panel, in particular a picture, mirror or the like, which has a V-shaped groove 19 cut into its cross-section in an edge region of a plate-shaped electroacoustic transducer, in order to be able to form a corner region with flanks bent backwards out of the sound-emitting surface.

The synthetic resin layers 6 thus also cover the flanks of the finished panel, the flanks being bent like a film hinge around the sound-emitting surface-side metal layer 11, which is not completely cut through, or the carrier material 4, which is not completely cut through.

1. An electroacoustic transducer transducer comprising:
at least one bending-resistant acoustic diaphragm; and
a structure-borne sound transducer that causes the acoustic diaphragm to vibrate;
wherein the acoustic diaphragm comprises a synthetic resin-coated carrier material having a sound-emitting surface that is formed by at least two synthetic resin layers that are firmly bonded to one another without any bonding agent or adhesive.

2. The electroacoustic transducer according to claim 1, wherein the synthetic resin of the synthetic resin layers is based on a polymer system that can be crosslinked by polyaddition.

3. The electroacoustic transducer according to claim 2, wherein the synthetic resin is a two-component epoxy synthetic resin system that comprises an amine-based hardener or a three-component polyurethane system that comprises a hardener based on blocked isocyanates.

4. The electroacoustic transducer according to claim 1, wherein the carrier material is selected from a group consisting of a composite material in a sandwich construction, a textile, a hollow body, a body made of glass-fibre reinforced plastic, and a wooden body.

5. The electroacoustic transducer according to claim 1, wherein the structure-borne sound transducer is connected to the acoustic diaphragm via a connecting element attached to the acoustic diaphragm or integrated in the acoustic diaphragm.

6. The electroacoustic transducer according to claim 5, wherein the structure-borne sound transducer is connected to the connecting element via a coupler and the structure-borne sound transducer is arranged at a distance of 2 to 800 mm from the acoustic diaphragm.

7. The electroacoustic transducer according to claim 5, wherein the structure-borne sound transducer is suspended in a housing of the electroacoustic transducer so as to oscillate freely with respect to the acoustic diaphragm.

8. The electroacoustic transducer according to claim 1, wherein the carrier material is in a sandwich construction comprising two metal layers, between which an electrically insulating core is arranged, wherein electrical lines leading from a connection point to the structure-borne sound transducer are incorporated in the manner of a printed circuit board into at least one of the two metal layers.

9. The electroacoustic transducer according to claim 8, wherein the connection point has a negative and/or positive contact pole and the structure-borne sound transducer has a contact point that has a negative and/or positive contact pole, and the contact poles are each formed by an adhesive electrode electrically connected to a respective negative electrical line or positive electrical line.

10. The electroacoustic transducer according to claim 1, wherein the structure-borne sound transducer is supported in a gas-tight envelope filled with an inert gas.

11. The electroacoustic transducer according to claim 1, wherein the structure-borne sound transducer is arranged between the acoustic diaphragm and a bass reflex bell so as to form a bass reflector.

12. A method for producing the acoustic diaphragm for an electroacoustic transducer according to claim 1, said method comprising:
applying a first synthetic resin layer to a sound-emitting surface of a shaping carrier material; and
before the first synthetic resin layer has completely cured, applying a second synthetic resin layer to the first synthetic resin layer such that the first and second synthetic resin layers are firmly bonded to one another without the use of a bonding agent or an adhesive.

13. A method according to claim 12, wherein the applying of the first synthetic resin layer uses a quantity of 1.2 to 3.2 kg/m² and the applying of the second synthetic resin layer uses a quantity of 0.6 to 1.2 kg/m².

14. A method according to claim 18, wherein the synthetic resin layers are applied to the carrier material up to a total thickness of 3.5 mm.

15. An acoustic diaphragm produced by a method according to claim 11.

16. The electroacoustic transducer according to claim 1, wherein the acoustic diaphragm comprises a synthetic resin-coated carrier material having a sound-emitting surface that is formed by at least three synthetic resin layers that are firmly bonded to one another without any adhesive or bonding agent.

17. The electroacoustic transducer according to claim 8, wherein the two metal layers are aluminum layers.

18. A method according to claim 12, wherein the method further comprises applying one or more additional synthetic resin layers, each of said additional synthetic resin layers being applied to an earlier-applied synthetic resin layer before the earlier-applied synthetic resin layer has completely cured, such that the additional synthetic resin layer is firmly bonded to the earlier-applied synthetic resin layer without any bonding agent or adhesive material.

19. A method according to claim 18, wherein the applying of the first synthetic resin layer uses a quantity of 2 to 2.4 kg/m² and the applying of the second synthetic resin layer and each additional synthetic resin layer uses a quantity of 0.8 to 1 kg/m².

20. A method according to claim 18, wherein the applying of the first synthetic resin layer uses a quantity of 2.2 kg/m² and the applying of the second synthetic resin layer and each additional synthetic resin layer uses a quantity of 0.9 kg/m².

21. A method according to claim 13, wherein the method further comprises vibrating the carrier material using a vibrator during the application of the synthetic resin layers.
